(19) United States
(12) Patent Application Publication
(10) Pub. No.: US 2023/0364574 A1
(43) Pub. Date: Nov. 16, 2023

(54) VESSEL SYSTEM FOR PRE ACTIVATING A SOLID CATALYST AND METHOD THEREOF

(71) Applicant: Basell Polyolefine GmbH, Wesseling (DE)

(72) Inventors: Tiziana Caputo, Ferrara (IT); Pietro Baita, Ferrara (IT); Maria Di Diego, Ferrara (IT); Lorella Marturano, Ferrara (IT); Antonio Mazzucco, Ferrara (IT); Gabriele Mei, Ferrara (IT); Giulia Mei, Ferrara (IT); Roberta Pica, Ferrara (IT)

(73) Assignee: Basell Polyolefine GmbH, Wesseling (DE)

(21) Appl. No.: 18/027,882

(22) PCT Filed: Sep. 21, 2021
(86) PCT No.: PCT/EP2021/075885

§ 371 Date: Mar. 22, 2023

(30) Foreign Application Priority Data
Sep. 23, 2020 (EP) 20197715.4

(51) Int. Cl. B01J 8/10; B01J 8/08; B01J 8/00; C08F 2/01; C08F 4/619; C08F 110/02

(52) U.S. Cl. CPC B01J 8/10; B01J 8/085; B01J 8/003; C08F 2/01; C08F 4/61912; C08F 110/02; B01J 2208/00752; B01J 2208/00761

(57) ABSTRACT

An apparatus for polymerizing olefins including a polymerization reactor and a vessel system for pre-activating a solid catalyst component, wherein the vessel system is arranged upstream of the polymerization reactor. The vessel system includes a contacting vessel which includes a main portion, a base portion, a head portion, an inlet, an outlet, and a stirrer positioned within the contacting vessel, wherein the ratio (H/D) of the height (H) of the main portion to the diameter (D) of the main portion is 1.8 or greater. The stirrer is located at a position between the inlet and the outlet.

### FIELD OF THE INVENTION

In general, the present disclosure relates to the field of chemistry. More specifically, the present disclosure relates to polymer chemistry. In particular, the present disclosure relates to a vessel system for pre-activating a solid catalyst component used in the polymerization of one or more 1-olefins and processes employing such a vessel system.

### BACKGROUND OF THE INVENTION

In some instances and in the polymerization of 1-olefins (such as ethylene and propylene), the pre-activation of the catalyst component facilitates catalyst productivity and the resulting polyolefin particle morphology. In some instances, increased catalyst activity results in the use of less catalyst, thereby providing economic benefits and reducing the level of catalyst-related residues in the polymeric product (that is, increased purity of the polymeric product). In some instances, improved polymer morphology facilitates reactor operability and prevents fouling in the polymerization reactor or in the recycle line.

### SUMMARY OF THE INVENTION

In a general embodiment, the present disclosure provides an apparatus for polymerizing olefins including a polymerization reactor and a vessel system for pre-activating a solid catalyst component, wherein the vessel system is arranged upstream of the polymerization reactor with respect to the flow of the solid catalyst component and includes
(a) a contacting vessel including
   (a.i) a main portion, wherein the main portion is a vertically arranged cylinder;
   (a.ii) a base portion;
   (a.iii) a head portion;
   (a.iv) an inlet, connecting the space outside the contacting vessel with the inside of the contacting vessel; and
   (a.v) an outlet, connecting the inside of the contacting vessel with the space outside the contacting vessel;
   wherein the ratio (H/D) of the height (H) of the main portion to the diameter (D) of the main portion, calculated by dividing the height (H) by the diameter (D), is 1.8 or greater; and
(b) a stirrer positioned within the contacting vessel, wherein the stirrer is located at a position in the contacting vessel between the inlet and the outlet.

In some embodiments, the ratio (H/D) of the main portion to the diameter (D) of the main portion is from 1.8 to 15.

In some embodiments, the ratio (H/D) of the main portion to the diameter (D) of the main portion is from 2.0 to 5.0.

In some embodiments, the contacting vessel includes at least two inlets, connecting the space outside the contacting vessel with the inside of the contacting vessel.

In some embodiments, the height (H) of the main portion is from 100 mm to 20 000 mm.

In some embodiments, the diameter (D) of the main portion is from 20 mm to 5 000 mm.

In some embodiments, the inlet and the outlet are situated in the vessel such that a height differential in the vertical direction exists between the respective positions of the inlet and the outlet.

In some embodiments, the inlet is positioned such that material or fluid passing through the inlet into the contacting vessel enters the contacting vessel at a point above the uppermost stirrer and wherein the outlet is positioned such that material or fluid passing from the inside of the contacting vessel through the outlet exits the contacting vessel at a point below the lowermost stirrer.

In some embodiments, the inlet is positioned such that material or fluid passing through the inlet into the contacting vessel enters the contacting vessel at a point below the lowermost stirrer and wherein the outlet is positioned such that material or fluid passing from the inside of the contacting vessel through the outlet exits the contacting vessel at a point above the uppermost stirrer.

In some embodiments, the inlet and the outlet are vertically positioned in the contacting vessel such that material or fluid passing through the inlet into the contacting vessel and passing through the contacting vessel to the outlet passes along at least 75%, alternatively at least 80%, alternatively at least 90%, alternatively at least 95%, alternatively 100%, of the height of the main portion prior to exiting the contacting vessel through the outlet.

In some embodiments, the stirrer is a set of impellers.

In some embodiments, the contacting vessel further includes one or more baffles.

In some embodiments, the present disclosure provides a process for preparing a pre-activated solid catalyst component for use in the polymerization of one or more 1-olefins, employs a vessel system including
(a) a contacting vessel including
   (a.i) a main portion, wherein the main portion is a vertically arranged cylinder;
   (a.ii) a base portion;
   (a.iii) a head portion;
   (a.iv) an inlet, connecting the space outside the contacting vessel with the inside of the contacting vessel; and
   (a.v) an outlet, connecting the inside of the contacting vessel with the space outside the contacting vessel;
   wherein the ratio (H/D) of the height (H) of the main portion to the diameter (D) of the main portion, calculated by dividing the height (H) by the diameter (D), is 1.8 or greater; and
(b) a stirrer positioned within the contacting vessel,
   wherein the stirrer is located at a position in the contacting vessel between the inlet and the outlet,
and includes the steps of
(i) forming a mixture by continuously feeding into the contacting vessel through the inlet
   (i.i) a non-activated and/or partially activated solid catalyst component,
   (i.ii) an activating compound made from or containing an organometallic compound of an element of Group 1, 2, 12, 13, or 14 of the Periodic Table of Elements,
   (i.iii) a diluent,
   and optionally
   (i.iv) an external electron donor compound, or
   (i.v) an activity enhancer compound selected from the group consisting of halogenated alkanols, haloalkanes, halocycloalkanes, and combinations thereof;
(ii) passing the mixture through the contacting vessel in the vertical direction to the outlet; and
(iii) continuously removing the mixture, containing the pre-activated solid catalyst component, through the outlet.

In some embodiments of the process, the contacting vessel includes at least two inlets connecting the space outside the contacting vessel with the inside of the contacting vessel and the non-activated and/or partially activated solid catalyst component is fed into the contacting vessel through a first of the inlets and the activating compound is fed into the contacting vessel through a second of the inlets.

In some embodiments, the pre-activated solid catalyst component is a pre-activated solid catalyst component for use in a Ziegler-Natta polymerization.

In some embodiments, the present disclosure provides a process including the step of polymerizing one or more 1-olefins in the presence of a polymerization catalyst system.

In some embodiments, the 1-olefins are selected from the group consisting of ethylene, propylene, 1-butene, 1-hexene, 1-octene, and combinations thereof.

### BRIEF DESCRIPTION OF THE DRAWINGS

FIG. 1 is a schematic of a vessel system having a H/D ratio of the main portion (vertically arranged cylinder) of the contacting vessel of 2.8.

### DETAILED DESCRIPTION OF THE INVENTION

In some embodiments, the present disclosure provides a vessel system, wherein, in a single contacting vessel, an increased number of theoretical contacting stages is realized, thereby employing a single contacting vessel instead of multiple contacting vessels or allowing a greater level of solid catalyst component pre-activation in multiple vessel systems. In some embodiments, the vessel system is part of an apparatus for polymerizing olefins further including a polymerization reactor.

In some embodiments, the present disclosure provides an apparatus for polymerizing olefins including a polymerization reactor and a vessel system for pre-activating a solid catalyst component, wherein the vessel system is arranged upstream of the polymerization reactor with respect to the flow of the solid catalyst component and includes
(a) a contacting vessel including
   (a.i) a main portion, wherein the main portion is a vertically arranged cylinder;
   (a.ii) a base portion;
   (a.iii) a head portion;
   (a.iv) an inlet, connecting the space outside the contacting vessel with the inside of the contacting vessel; and
   (a.v) an outlet, connecting the inside of the contacting vessel with the space outside the contacting vessel;
   wherein the ratio (H/D) of the height of the vertically arranged cylinder (H) to the diameter of the vertically arranged cylinder (D), calculated by dividing the height of the vertically arranged cylinder by the diameter of the vertically arranged cylinder, is 1.8 or greater; and
(b) a stirrer positioned within the contacting vessel,
   wherein the stirrer is located at a position in the contacting vessel between the inlet and the outlet.

In some embodiments, the vessel system gives rise to a plug-flow through the contacting vessel, wherein, in contrast to contacting vessels based on a continuous stirred tank design, realizes more than one contacting stage and increases the level/degree of activation of a pre-activated solid catalyst component.

In some embodiments, the contacting vessel includes a main portion being a vertically arranged cylinder. In some embodiments, the ratio of the height of the vertically arranged cylinder (H) to the diameter of the vertically arranged cylinder (D) (also referred to as the height/diameter ratio or H/D ratio) is 1.8 or greater. As used herein, the “diameter of the vertically arranged cylinder” refers to the internal diameter of the cylinder, that is, not including the thickness of the cylinder walls. In some embodiments, this ratio is less than 1.8 and a single contacting stage is realized in the vessel. In some embodiments, the ratio is less than 1.8 and yields little or no improvement in the pre-activated proportion of material (solid catalyst component) relative to a comparative pre-activated solid catalyst component. In some embodiments, mechanical considerations dictate an upper value of the H/D ratio. In some embodiments, the mechanical considerations include shaft stability, vibrations, or mechanical integrity. In some embodiments, the H/D ratio is from 1.8 to 15, alternatively from 2.0 to 5.0, alternatively from 2.5 to 3.5.

In some embodiments, the height of the vertically arranged cylinder (H) of the contacting vessel is from 100 mm to 20 000 mm. In some embodiments, the height is from 100 mm to 10 000 mm, alternatively from 150 mm to 5 000 mm, alternatively from 200 mm to 3 000 mm, alternatively from 250 mm to 2 000 mm. In some embodiments, the diameter (D) of the vertically arranged cylinder of the contacting vessel is from 20 mm to 5 000 mm, alternatively from 40 mm to 2 500 mm, alternatively from 50 mm to 1 500 mm, alternatively from 70 mm to 1 000 mm, alternatively from 75 mm to 750 mm.

In some embodiments, the vertically arranged cylinder has a height of from 100 mm to 20 000 mm, a diameter of from 20 mm to 5 000 mm, and an H/D ratio of 1.8 to 15; alternatively a height of from 100 mm to 10 000 mm, a diameter of from 40 mm to 2 500 mm, and an H/D ratio of 2.0 to 5.0; alternatively a height of from 250 mm to 2 000 mm, a diameter of from 40 mm to 2 500 mm and an H/D ratio of 2.5 to 3.5.

In some embodiments, the contacting vessel further includes an inlet, alternatively at least two inlets, connecting the space outside the contacting vessel with the inside of the contacting vessel, and an outlet, connecting the inside of the contacting vessel with the space outside the contacting vessel. In some embodiments, the inlet, alternatively at least two inlets, and the outlet are situated in the vessel such that a height differential in the vertical direction exists between the respective positions of the inlet(s) and the outlet. In some embodiments, the inlet(s) are positioned such that material or fluid passing through the inlet(s) into the contacting vessel enters the contacting vessel at a point above the uppermost stirrer and the outlet is positioned such that material or fluid passing from the inside of the contacting vessel through the outlet exits the contacting vessel at a point below the lowermost stirrer. In some embodiments, this configuration yields a top-to-bottom flow of materials. In some embodiments, the outlet is positioned on the base portion. In some embodiments, the outlet is positioned on the base portion such that material or fluid passing from the inside of the contacting vessel through the outlet exits the contacting vessel with the same direction of flow with which the material or fluid passed from the inlet through the main portion and arrived at the outlet. In some embodiments, the outlet is positioned on the main portion of the contacting vessel.

In some embodiments, the inlet(s) are positioned such that material or fluid passing through the inlet(s) into the contacting vessel enters the contacting vessel at a point below the lowermost stirrer and the outlet is positioned such that material or fluid passing from the inside of the contacting vessel through the outlet exits the contacting vessel at a point above the uppermost stirrer. In some embodiments, this configuration yields a bottom-to-top flow of materials. In some embodiments, the outlet is positioned on the head portion. In some embodiments, the outlet is positioned on the head portion such that material or fluid passing from the inside of the contacting vessel through the outlet exits the contacting vessel with the same direction of flow with which the material or fluid passed from the inlet through the main portion and arrived at the outlet. In some embodiments, the outlet is positioned on the main portion of the contacting vessel.

In some embodiments, the contacting vessel includes a single inlet. In some embodiments, the contacting vessel includes more than one inlet. In some embodiments, the contacting vessel includes at least two inlets connecting the space outside the contacting vessel with the inside of the contacting vessel. In some embodiments, the mixture for pre-activating the solid catalyst component is made from or containing the solid catalyst component, an activating compound, a donor compound, an activity enhancer compound, an antistatic agent, and/or a diluent. In some embodiments, the donor compound is an internal electron donor compound or an external electron donor compound. In some embodiments, these materials are added to the contacting vessel through a single inlet, alternatively through one or more additional inlets. In some embodiments, the contacting vessel is provided with an inlet for each of the different materials to be employed in the contacting process.

In some embodiments, the inlet, alternatively at least two inlets, and the outlet are positioned such that material or fluid entering the contacting vessel by passing through the inlet(s) and subsequently exiting the contacting vessel through the outlet passes along a minimum proportion of the height of the main portion of the contacting vessel. In some embodiments and regarding the minimum proportion of the height of the main portion of the contacting vessel, the inlet, alternatively at least two inlets, and the outlet are vertically positioned in the contacting vessel such that material or fluid passing through the inlet(s) into the contacting vessel and passing through the contacting vessel to the outlet passes along at least 75% of the height of the main portion prior to exiting the contacting vessel through the outlet. In some embodiments, the inlet, alternatively at least two inlets, and the outlet are vertically positioned in the contacting vessel such that any material or fluid passing through the inlet(s) into the contacting vessel and passing through the contacting vessel to the outlet passes along at least 80%, alternatively at least 90%, alternatively at least 95%, alternatively 100%, of the height of the main portion prior to exiting the contacting vessel through the outlet.

In some embodiments, the vessel system (1) further a stirrer positioned within the contacting vessel. In some embodiments, the stirrer enables mixing of materials and fluids present in and/or passing through the contacting vessel. In some embodiments, the stirrer is arranged to ensure complete mixing of the components present throughout the entire main portion. In some embodiments, more than one stirrer is present and there is a height differential in the vertical direction between the stirrers. In some embodiments, the presence of more than one stirrer facilitates a more consistent degree of mixing throughout the contacting vessel. In some embodiments, from 2 to 15 stirrers are positioned within the contacting vessel. In some embodiments, from 2 to 5, alternatively from 2 to 4, stirrers are positioned within the contacting vessel. In some embodiments, the contacting vessel includes three or more stirrers, the height differential in the vertical direction between a first stirrer and the second stirrer, located immediately adjacent to the first stirrer, is equal to height differential for the stirrers and the stirrers' adjacent stirrer within the vessel. In other words, the stirrers are equally spaced in the vertical direction. In the embodiments, equal spacing facilitates optimal (complete) mixing. In some embodiments, the stirrers are positioned within the contacting vessel to rotate about an axis which is concentric with the vertical central axis of the main portion.

In some embodiments, the nature of the stirrers is not per se limited. In some embodiments, the stirrer(s) are configured to produce tangential flow of the materials and fluids passing through the contacting vessel. In some embodiments, the stirrer(s) are impellers. In some embodiments, the impellers are selected from the group consisting of upward orientated impellers, downward orientated impellers, and flat-blade-type impellers. In some embodiments, the impellers are flat-blade-type impellers, which are believed to produce a greater degree of tangential flow. In some embodiments, the impellers are flat-blade-type impellers and the number of blades on each impeller ensure tangential flow of the materials through the contacting vessel. In some embodiments, each impeller has 2 or more blades, alternatively from 2 to 20 blades. In some embodiments, the flat-blade-type impellers have 3 blades or 4 blades per impeller.

In some embodiments, the contacting vessel further includes a base portion and a head portion. In some embodiments, the base portion is configured to provide the contacting vessel with a lower surface and the head portion is configured to provide the contacting vessel with an upper surface. In some embodiments, the main portion, which is a vertically arranged cylinder, the base portion, and the head portion together result in a closed vessel. In some embodiments and among other things, the base portion serves to close the vertically arranged cylinder of the main portion at the vertically arranged cylinder's lower end. In some embodiments and among other things, the head portion serves to close the vertically arranged cylinder of the main portion at the vertically arranged cylinder's upper end. In some embodiments, one of or both the head and base portions are physically adjoined to the main portion such that the adjoined portion(s) are inseparable from the main portion. In some embodiments, one of or both the head and base portions and the main portion form a single, continual physical entity. In some embodiments, one of or both the head and base portions are detachable from the main portion. In some embodiments, the head portion is a reactor vessel head which is detachable from the remainder of the contacting vessel. In some embodiments, the base portion of the contacting vessel is connected to the main portion of the contacting vessel to form a single, continual physical entity (joining the opposing sides of the main portion to one another by way of a rounded surface) and the head portion is a detachable reactor vessel head wherein the inlets are positioned.

In some embodiments, baffles are used in reaction vessels, thereby improving turbulence and mixing. In some embodiments, the contacting vessel further includes one or more baffles. In some embodiments, the baffles are adjoined to the inner surface of the contacting vessel, thereby minimizing dead space within the vessel. In some embodiments, the baffle(s) are adjoined to the side wall of the vessel at one, two, or three points, alternatively, to the inner surface of the head portion. In some embodiments, a combination of baffles is attached to the side wall of the vessel and to the inner surface of the head portion. In some embodiments, other baffle constellations are used.

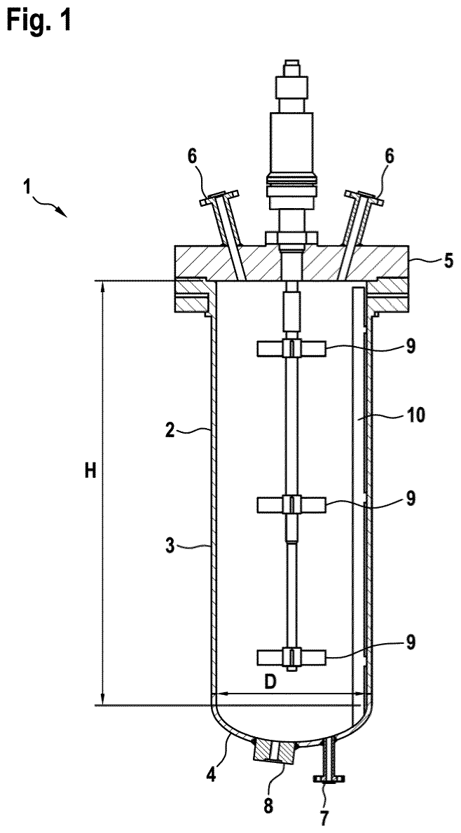

FIG. 1 is a schematic, showing a vessel system. The vessel system (1) includes a contacting vessel (2) having a main portion (3), a base portion (4), and a head portion (5). For connecting the space outside the contacting vessel with the inside of the contacting vessel, the contacting vessel (2) has two inlets (6), an outlet (7), and an emergency discharge outlet (8). The vessel system further exhibits three concentrically arranged stirrers (9) in the form of flat-blade-type impellers and a baffle (10) adjoined to the side wall of the vessel at three points.

In some embodiments, the vessel system further includes an element for controlling the temperature within the contacting vessel.

In some embodiments, the disclosed apparatus is used in a process for polymerization of olefins, which includes a step of preparing pre-activated solid catalyst components. In some embodiments, the process is for the polymerization of one or more 1-olefins. In some embodiments, the polymerization uses Ziegler-Natta catalysts. In some embodiments, the pre-activation of the solid catalyst component in a contacting vessel facilitates higher catalyst mileage, lower catalyst incidence on the final polymer product cost, increased specific mileage, improved polymer morphology, a lower quantity fines, and/or increased pour bulk density. In some embodiments, improved polymer morphology is demonstrated in particle size distribution. As used herein, the term “fines” refers to polymer particles having a diameter below 180 μm.

In some embodiments, the vessel system increases the proportion of pre-activated material than in a process using a continuous stirred tank.

In some embodiments, the present disclosure provides an apparatus for use in a polymerization of olefins which includes a preparation of a pre-activated solid catalyst component. In some embodiments, the pre-activated solid catalyst component is prepared by contacting in the vessel system a non-activated and/or partially activated solid catalyst component with a co-catalyst. In some embodiments, the pre-activated solid catalyst components are solid catalyst components for the polymerization of one or more 1 olefins, alternatively solid catalyst components of Ziegler-Natta catalysts.

In some embodiments, the pre-activated solid catalyst components are pre-activated solid catalyst components for use in the polymerization of 1-olefins. In some embodiments, the vessel systems are used to prepare pre-activated catalyst components, alternatively pre-activated Ziegler-Natta catalyst components. In some embodiments, the pre-activated catalyst components are used in subsequent polymerization reactions. In some embodiments, the resulting polymers are homopolymers or copolymers of 1-olefins. In some embodiments, the 1-olefins are selected from the group consisting of ethylene, propylene, 1-butene, 1-hexene, 1-octene, and combinations thereof. In some embodiments, the pre-activated catalyst components are used in the polymerization of ethylene. In some embodiments, the resulting polyethylene is HDPE or LLDPE. In some embodiments, the pre-activated catalyst components are used in the polymerization of propylene. In some embodiments, the resulting polypropylene is a propylene homopolymer, a propylene random copolymer, or a heterophasic propylene copolymer. In some embodiments, the pre-activated catalyst components are used in the copolymerization of ethylene and a further 1-olefin selected from the group consisting of propylene, 1-butene, 1-hexene, and 1-octene, and combinations thereof. In some embodiments, the pre-activated catalyst components are used in the copolymerization of propylene and a further 1-olefin selected from the group consisting of ethylene, 1-butene, 1-hexene, 1-octene, and combinations thereof.

In some embodiments, two or more of the vessel systems in series are used to prepare the pre-activated solid catalyst component. In some embodiments, the pre-activated solid catalyst component produced in a first vessel system (or a mixture containing the pre-activated solid catalyst component obtained from the first vessel system) is fed into a second vessel system, wherein a second pre-activating, contacting step is performed.

In some embodiments, the present disclosure provides a process using a vessel system for preparing a pre-activated solid catalyst component for use in the polymerization of one or more 1-olefins. In some embodiments, the process uses a vessel system including
(a) a contacting vessel including
   (a.i) a main portion, wherein the main portion is a vertically arranged cylinder;
   (a.ii) a base portion;
   (a.iii) a head portion;
   (a.iv) an inlet, connecting the space outside the contacting vessel with the inside of the contacting vessel; and
   (a.v) an outlet, connecting the inside of the contacting vessel with the space outside the contacting vessel;
   wherein the ratio (H/D) of the height (H) of the main portion to the diameter (D) of the main portion, calculated by dividing the height (H) by the diameter (D), is 1.8 or greater; and
(b) a stirrer positioned within the contacting vessel, wherein the stirrer is located at a position in the contacting vessel between the inlet and the outlet, and
includes the steps of
(i) forming a mixture by continuously feeding into the contacting vessel through the inlet
   (i.i) a non-activated and/or partially activated solid catalyst component,
   (i.ii) an activating compound made from or containing an organometallic compound of an element of Group 1, 2, 12, 13, or 14 of the Periodic Table of Elements,
   (i.iii) a diluent,
   and optionally
   (i.iv) an external electron donor compound, and/or
   (i.v) an activity enhancer compound selected from the group consisting of halogenated alkanols, haloalkanes, halocycloalkanes, and combinations thereof;
(ii) passing the mixture through the contacting vessel in the vertical direction to the outlet; and
(iii) continuously removing the mixture containing the pre-activated solid catalyst component through the outlet.

In some embodiments, the contacting vessel includes at least two inlets connecting the space outside the contacting vessel with the inside of the contacting vessel and the non-activated and/or partially activated solid catalyst component is fed into the contacting vessel through a first of the inlets and the activating compound is fed into the contacting vessel through a second of inlets.

In some embodiments and during step (ii), the non-activated and/or partially activated solid catalyst component, the activating compound, the diluent, and, where present, the external electron donor compound and/or the activity enhancer compound are contacted under agitation by the stirrer at a temperature of 0° C. to 70° C., alternatively at a temperature of 15° C. to 65° C., alternatively at a temperature of 35° C. to 55° C.

In some embodiments and during step (ii), the mixture is passed through the contacting vessel at a rate such that the residence time of the components (i.i), (i.ii), (i.iii) and, where present, (i.iv) and (i.v) in contact with one another in the contacting vessel is from 5 minutes to 5 hours, alternatively from 20 minutes to 4 hours, alternatively from 30 minutes to 3 hours.

In some embodiments, the contacting components (i.i), (i.ii), (i.iii) and, where present, (i.iv) and (i.v) are conducted in two or more contacting vessels arranged in series. In some embodiments, the combined residence time of the components in the contacting vessels arranged in series is from 5 minutes to 5 hours, alternatively from 20 minutes to 4 hours, alternatively from 30 minutes to 3 hours.

In some embodiments, the non-activated and/or partially activated solid catalyst component are used in the polymerization of one or more 1-olefins. In some embodiments, the non-activated and/or partially activated solid catalyst component is made from or containing a compound of titanium or a compound of vanadium; a compound of magnesium; and optionally an internal electron donor compound and/or an inorganic oxide support material. In some embodiments, the non-activated and/or partially activated solid catalyst component is obtained by contacting a compound of titanium; a compound of magnesium; and, where present, an internal electron donor compound and/or an inorganic oxide support material.

In some embodiments, the non-activated and/or partially activated solid catalyst component is made from or containing a compound of titanium. In some embodiments, the compound of titanium is selected from the group consisting of halides of trivalent titanium, halides of tetravalent titanium, alkoxides of trivalent titanium, alkoxides of tetravalent titanium, alkoxy halogen compounds of trivalent titanium, alkoxy halogen compounds of tetravalent titanium, and combinations thereof. In some embodiments, the compounds of titanium are selected from the group consisting of TiBr₃, TiBr₄, TiCl₃, TiCl₄, Ti(OCH₃)Cl₃, Ti(OC₂H₅)Cl₃, Ti(O—i—C₃H₇)Cl₃, Ti(O—n—C₄H₉)Cl₃, Ti(OC₂H₅)Br₃, Ti(O—n—C₄H₉)Br₃, Ti(OCH₃)₂Cl₂, Ti(OC₂H₅)₂Cl₂, Ti(O—n—C₄H₉)₂Cl₂, Ti(OC₂H₅)₂Br₂, Ti(OCH₃)₃Cl, Ti(OC₂H₅)₃Cl, Ti(O—n—C₄H₉)₃Cl, Ti(OC₂H₅)₃Br, Ti(OCH₃)₄, Ti(OC₂H₅)₄, Ti(O—n—C₄H₉)₄, and combinations thereof. In some embodiments, the compound of titanium is made from or containing a halogen, alternatively a chlorine atom. In some embodiments, the titanium compound is a compound consisting of trivalent- or tetravalent-titanium and halogen atoms, alternatively trivalent- or tetravalent-titanium and chlorine atoms. In some embodiments, the titanium compound is titanium tetrachloride.

In some embodiments, the non-activated and/or partially activated solid catalyst component is made from or containing a compound of vanadium. In some embodiments, the compound of vanadium is selected from the group consisting of vanadium (III) compounds, vanadium (IV) compounds, vanadium (V) compounds, and combinations thereof. In some embodiments, the compound of vanadium is selected from the group consisting of vanadium halides, vanadium oxyhalides, vanadium alkoxides, vanadium acetylacetonates, and combinations thereof.

In some embodiments, the non-activated and/or partially activated solid catalyst component are made from or containing compounds of magnesium. In some embodiments, the compounds of magnesium are halogenated magnesium compounds. In some embodiments, the halogenated magnesium compounds are magnesium halides, alternatively selected from the group consisting of magnesium chlorides and magnesium bromides. In some embodiments, the halogenated magnesium compounds are made from or containing halogens selected from the group consisting of chlorine, bromine, iodine, fluorine, and combinations thereof. In some embodiments, the halogen is selected from the group consisting of chlorine and bromine, alternatively chlorine.

In some embodiments, the halogenated magnesium compounds are magnesium chlorides or magnesium bromides. In some embodiments, the magnesium halides are prepared from reacting halogenating agents with magnesium alkyls, magnesium aryls, magnesium alkoxy compounds, magnesium aryloxy compounds, and Grignard compounds. In some embodiments, the halogenating agents are selected from the group consisting of halogens, hydrogen halides, SiCl₄, and CCl₄. In some embodiments, the halogenating agents are chlorine or hydrogen chloride.

In some embodiments, magnesium alkyls, magnesium aryls, magnesium alkoxy compounds, and magnesium aryloxy compounds include diethylmagnesium, di-n-propylmagnesium, diisopropylmagnesium, di-n-butylmagnesium, di-sec-butylmagnesium, di-tert-butylmagnesium, diamylmagnesium, n-butylethylmagnesium, n-butyl-sec-butylmagnesium, n-butyloctylmagnesium, diphenylmagnesium, diethoxymagnesium, di-n-propyloxymagnesium, diisopropyloxymagnesium, di-n-butyloxymagnesium, di-sec-butyloxymagnesium, di-tert-butyloxymagnesium diamyloxymagnesium, n-butyloxyethoxymagnesium, n-butyloxy-sec-butyloxymagnesium, n-butyloxyoctyloxymagnesium and diphenoxymagnesium. In some embodiments, the magnesium alkyl is n-butylethylmagnesium or n-butyloctylmagnesium.

In some embodiments, the Grignard compounds include methylmagnesium chloride, ethylmagnesium chloride, ethylmagnesium bromide, ethylmagnesium iodide, n-propylmagnesium chloride, n-propylmagnesium bromide, n-butylmagnesium chloride, n-butylmagnesium bromide, sec-butylmagnesium chloride, sec-butylmagnesium bromide, tert-butylmagnesium chloride, tert-butylmagnesium bromide, hexylmagnesium chloride, octylmagnesium chloride, amylmagnesium chloride, isoamylmagnesium chloride, phenylmagnesium chloride, and phenylmagnesium bromide.

In some embodiments, the compounds of magnesium are selected from the group consisting of magnesium dichloride, magnesium dibromide, and di(C₁-C₁₀-alkyl)magnesium compounds. In some embodiments, the compound of magnesium is made from or containing magnesium dichloride.

In some embodiments, the non-activated and/or partially activated solid catalyst component is made from or containing an internal electron donor compound. In some embodiments, the non-activated and/or partially activated solid catalyst component is obtained by contacting a compound of titanium; a compound of magnesium; an internal electron donor compound; and, where present, an inorganic oxide support material.

In some embodiments, the internal electron donor compounds are selected from internal electron donor compounds employed in catalysts used in the polymerization of 1-olefins. In some embodiments, the internal electron donor compounds are selected from the group consisting of alcohols, glycols, esters, ketones, amines, amides, nitriles, alkoxysilanes, aliphatic ethers, and combinations thereof. In some embodiments, the electron donor compounds are used alone or in mixtures with other electron donor compounds.

In some embodiments, the alcohols have the formula R¹OH, wherein the R₁ group is a C₁₋₂₀ hydrocarbon group. In some embodiments, R¹ is a C₁₋₁₀ straight chain or branched alkyl group. In some embodiments, the alcohols are selected from the group consisting of methanol, ethanol, iso-propanol, n-butanol, and combinations thereof. In some embodiments, the glycols have a total number of carbon atoms lower than 50. In some embodiments, the glycols are 1,2- or 1,3-glycols having a total number of carbon atoms lower than 25. In some embodiments, the glycols are selected from the group consisting of ethylene glycol, 1,2-propylene glycol, 1,3-propylene glycol, and combinations thereof. In some embodiments, the esters are alkyl esters of C₁₋₂₀ aliphatic carboxylic acids, alternatively C₁₋₈ alkyl esters of aliphatic mono carboxylic acids. In some embodiments, the C₁₋₈ alkyl esters of aliphatic mono carboxylic acids are selected from the group consisting of ethyl acetate, methyl formate, ethyl formate, methyl acetate, propyl acetate, i-propyl acetate, n-butyl acetate, i-butyl acetate, and combinations thereof. In some embodiments, the amines have the formula N(R²)₃, wherein the R² groups are independently selected from hydrogen and a C₁₋₂₀ hydrocarbon group with the proviso that not all R² groups are hydrogen. In some embodiments, R² is a C₁₋₁₀ straight chain or branched alkyl group. In some embodiments, the amines are selected from the group consisting of diethylamine, diisopropylamine, triethylamine, and combinations thereof. In some embodiments, the amides have the formula R³CON(R⁴)₂, wherein R³ and R⁴ are independently selected from hydrogen and a C₁₋₂₀ hydrocarbon group. In some embodiments, the amides are selected from the group consisting of formamide and acetamide. In some embodiments, the nitriles have the formula R¹CN, wherein the R¹ group is a C₁₋₂₀ hydrocarbon group. In some embodiments, R¹ is a C₁₋₁₀ straight chain or branched alkyl group. In some embodiments, the nitrile is acetonitrile. In some embodiments, the alkoxysilanes have the formula (R⁵)ₐ(R⁶)_{b}Si(OR⁷)_{c}, where a is an integer from 0 to 2, b is an integer from 0 to 2, c is an integer from 1 to 4 and the sum (a+b+c) is 4; R⁵, R⁶, and R⁷, are each independently selected from the group consisting of C₁₋₁₈ alkyl, C₁₋₁₈ cycloalkyl, and C₁₋₁₈ aryl. In some embodiments, one or more carbon atoms in each alkyl, cycloalkyl or aryl group is replaced with a heteroatom. In some embodiments, the heteroatom is O, N, or S. In some embodiments, the alkoxysilanes are wherein a is 0 or 1, c is 2 or 3, R⁶ is an C₁₋₁₈ alkyl or C₁₋₁₈ cycloalkyl group. In some embodiments, one or more carbon atoms in each alkyl or cycloalkyl group is replaced with a heteroatom and R⁷ is methyl. In some embodiments, the heteroatom is O, N, or S. In some embodiments, the alkoxysilanes are selected from the group consisting of methyltrimethoxysilane, dimethyldimethoxysilane, trimethylmethoxysilane, and t-butyltrimethoxysilane.

In some embodiments, the internal electron donor compounds are selected from the group consisting of esters, amides, alkoxysilanes, and combinations thereof.

In some embodiments, the compound of magnesium and the compound of titanium are first contacted, optionally in the presence of an inert diluent, thereby preparing an intermediate product containing a titanium compound supported on a magnesium halide. In some embodiments, the intermediate product is isolated. In some embodiments, the internal electron donor compound is contacted with the intermediate product. In some embodiments, the internal electron donor compound is added to the reaction mixture alone or in a mixture with other compounds. In some embodiments, the reaction product is subjected to washing with a solvent, thereby permitting recovery of a final non-activated and/or partially activated solid catalyst component. In some embodiment, the treatment with the internal electron donor compound is repeated a further one or more times.

In some embodiments, the non-activated and/or partially activated solid catalyst component is further made from or containing an inorganic oxide support material. In some embodiments, the inorganic oxide support material is selected from the group consisting of silica gel, aluminum oxide, aluminosilicates, and combinations thereof. In some embodiments, the inorganic oxide support material is in particulate form. In some embodiments, the non-activated and/or partially activated solid catalyst component is obtained by contacting a compound of titanium; a compound of magnesium; an internal electron donor compound; and an inorganic oxide support material. In some embodiments, the non-activated and/or partially activated solid catalyst component is absent a filler or porous catalyst support.

In some embodiments, the activating compound is an activating compound for use with a solid catalyst component for the polymerization of one or more 1-olefins. In some embodiments, the activating compound is made from or containing an organometallic compound of a metal of Group 1, 2, 12, 13, or 14 of the Periodic Table of Elements. In some embodiments, the activating compound is selected from the group consisting of an organometallic alkyl, organometallic alkoxide, organometallic halide, and combinations thereof. In some embodiments, the activating compound is selected from the group consisting of lithium alkyls, magnesium alkyls, zinc alkyls, magnesium alkyl halides, aluminum alkyls, silicon alkyls, silicon alkoxides, silicon alkyl halides, and combinations thereof. In some embodiments, the activating compounds are made from or containing organoaluminum compounds. In some embodiments, the organoaluminum compounds are aluminum alkyl compounds. In some embodiments, the aluminum alkyl compounds are selected from the group consisting of from trialkylaluminum compounds, alkylaluminum halides, alkylaluminum hydrides, alkylaluminum sesquichlorides, and combinations thereof. In some embodiments, the aluminum alkyl compounds are selected from the group consisting of trimethylaluminum, triethylaluminum, trii sobutylaluminum, tri-n-butylaluminum tri-n-hexylaluminum, tri-n-octylaluminum, diethylaluminum chloride, diisobutylaluminum chloride, dimethylaluminum chloride, ethylaluminum sesquichloride, and combinations thereof.

In some embodiments, the diluent is continuously fed into the contacting vessel through the inlet. In some embodiments, the diluent is a liquid under the contacting conditions employed in the contacting vessel and inert, that is, does not react with the components fed into the contacting vessel. In some embodiments, the diluent is a hydrocarbon. In some embodiments, the diluents are propane, n-hexane, n-heptane, or combinations thereof. In some embodiments, the diluent is propane. In some embodiments, the diluent is propane, and the contacting conditions includes a temperature of from −20° C. to 60° C. and a total pressure of 1.8 MPa or more. As used herein, pressure indications relate to absolute pressure.

In some embodiments, the external donor compound is continuously fed into the contacting vessel through the inlet. In some embodiments, the external electron donor compound is an external electron donor compound for use in preparing pre-activated solid catalyst components for use in the polymerization of 1-olefins. In some embodiments, pre-activation is achieved through the contacting of a non-activated and/or partially activated solid catalyst component with an activating compound. In some embodiments, the external electron donor compound is selected from the group consisting of alcohols, glycols, esters, ketones, amines, amides, nitriles, alkoxysilanes, aliphatic ethers, and combinations thereof. In some embodiments, the external electron donor compound is tetrahydrofuran.

In some embodiments, the activity enhancer compound is continuously fed into the contacting vessel through the inlet. In some embodiments, the activity enhancer compound is an activity enhancer compound used in preparing pre-activated solid catalyst components for use in the polymerization of 1-olefins. In some embodiments, pre-activation is achieved through the contacting of a non-activated and/or partially activated solid catalyst component with an activating compound. In some embodiments, the activity enhancer compound is selected from the group consisting of halogenated alkanols, haloalkanes, halocycloalkanes, halogenated esters, and combinations thereof. In some embodiments, the halogenated alkanols are halogenated C₁-C₆ alkanols, alternatively trichloroethanol (TCEt). In some embodiments, the haloalkanes are halogenated C₁-C₆ alkanes. In some embodiments, the halocycloalkanes are halogenated C₃-C₈ cycloalkanes, alternatively cyclohexyl chloride (CHC). In some embodiments, the halogenated esters are chloro esters, alternatively ethyl chloroacetate. In some embodiments, the halogen group(s) present in the activity enhancer compound is chlorine.

In some embodiments, the pre-activated solid catalyst components are for use in the polymerization of 1-olefins, alternatively for use in a Ziegler-Natta polymerization. In some embodiments, the vessel systems prepare pre-activated catalyst components, alternatively pre-activated Ziegler-Natta catalyst components, to generate a polymerization catalyst system for the polymerization of one or more 1-olefins.

In some embodiments, the present disclosure provides a process for preparing a polymer, including the steps of polymerizing one or more 1-olefins in the presence of a polymerization catalyst system prepared by a process for preparing a pre-activated solid catalyst component. In some embodiments, the polymerization process is carried out using low-pressure polymerization methods at temperatures in the range from 20 to 200° C., alternatively from 30 to 150° C., alternatively from 40 to 130° C., and under pressures of from 0.1 to 20 MPa, alternatively from 0.3 to 5 MPa. In some embodiments, the polymerization is carried out batchwise or continuously in one or more stages. In some embodiments, the polymerization is carried out using solution processes, suspension processes, or gas-phase processes. In some embodiments, the polymerization process is a gas-phase polymerization or a suspension polymerization. In some embodiments, the gas-phase polymerization is carried out in gas-phase fluidized-bed reactors or multizone circulating reactors. In some embodiments, the suspension polymerization is carried out in loop reactors or stirred tank reactors.

In some embodiments, the polymerization process is a suspension polymerization in a suspension medium. In some embodiments, the suspension medium is an inert hydrocarbon the monomers. In some embodiments, the inert hydrocarbon is isobutane or a mixture of hydrocarbons. In some embodiments, the suspension polymerization temperatures are in the range from 20 to 115° C., and the pressure is in the range of from 0.1 to 10 MPa. In some embodiments, the solids content of the suspension is in the range of from 10 to 80 wt. %. In some embodiments, the polymerization is carried out batchwise or continuously. In some embodiments, the batchwise process occurs in stirred autoclaves. In some embodiment, the continuous process occurs in tubular reactors, alternatively in loop reactors. In some embodiments, the polymerization process is carried out by the Phillips PF process as described in U.S. Pat. Nos. 3,242,150 and 3,248,179.

In some embodiments, the suspension medium is inert. In some embodiments, the suspension medium is liquid or supercritical under the reaction conditions. In some embodiments, the suspension medium has a boiling point different from the boiling points of the monomers and the comonomers, thereby permitting the recovery of starting materials from the product mixture by distillation. In some embodiments, the suspension media are saturated hydrocarbons having from 4 to 12 carbon atoms. In some embodiments, the saturated hydrocarbons are selected from the group consisting of isobutane, butane, propane, isopentane, pentane, hexane, and mixtures thereof. In some, the suspension medium is diesel oil.

In some embodiments, the suspension polymerization process takes place in a cascade of two stirred vessels, alternatively three or four stirred vessels. In some embodiments, the molecular weight of the polymer fraction is set by addition of hydrogen to the reaction mixture. In some embodiments, the polymerization process is carried out with the highest hydrogen concentration and the lowest comonomer concentration, based on the amount of monomer, being set in the first reactor. In the subsequent further reactors, the hydrogen concentration is gradually reduced and the comonomer concentration is altered, based on the amount of monomer. In some embodiments, the monomer is ethylene or propylene. In some embodiments, the comonomer is a 1-olefin having from 4 to 10 carbon atoms.

In some embodiments, the suspension polymerization process is suspension polymerization in loop reactors, where the polymerization mixture is pumped continuously through a cyclic reactor tube. It is believed that the pumped circulation yields continual mixing of the reaction mixture and distributes the catalyst and the monomers in the reaction mixture. Furthermore, the pumped circulation prevents sedimentation of the suspended polymer. In some embodiments, the pumped circulation promotes removal of the heat of reaction via the reactor wall. In some embodiments, these reactors consist of a cyclic reactor tube having one or more ascending legs, one or more descending legs, and horizontal tube sections connecting the vertical legs. In some embodiments, the descending legs are enclosed by cooling jackets for removal of the heat of reaction. In some embodiments, the impeller pump, the catalyst feed facilities, the monomer feed facilities, and the discharge facility are installed in the lower tube section. In some embodiments, the reactor has more than two vertical tube sections, thereby obtaining a meandering arrangement.

In some embodiments, the suspension polymerization is carried out in the loop reactor at an ethylene concentration of at least 5 mole percent, alternatively 10 mole percent, based on the suspension medium. In this context, the term “suspension medium” refers to the mixture of the fed suspension medium with the monomers dissolved therein. In some embodiments, the ethylene concentration is determined by gas-chromatographic analysis of the suspension medium.

In some embodiments, the polymerization process is carried out as gas-phase polymerization, that is, by a process wherein the solid polymers are obtained from a gas-phase of the monomer or the monomers. In some embodiments, the gas-phase polymerizations are carried out at pressures of from 0.1 to 20 MPa, alternatively from 0.5 to 10 MPa, alternatively from 1.0 to 5 MPa, and polymerization temperatures from 40 to 150° C., alternatively from 65 to 125° C.

In some embodiments, the gas-phase polymerization reactors are horizontally or vertically stirred reactor, fluidized bed gas-phase reactors, or multizone circulating reactors, alternatively fluidized bed gas-phase reactors or multizone circulating reactors.

In some embodiments, fluidized-bed polymerization reactors are reactors wherein the polymerization takes place in a bed of polymer particles maintained in a fluidized state by feeding in gas at the lower end of a reactor and taking off the gas at the upper end of the reactor. In some embodiments, the gas is fed below a gas distribution grid having the function of dispensing the gas flow. After exiting the upper end of the reactor, the reactor gas is returned to the lower end of the reactor via a recycle line equipped with a compressor and a heat exchanger. In some embodiments, the circulated reactor gas is a mixture of the olefins to be polymerized, inert gases, and optionally a molecular weight regulator. In some embodiments, the inert gases are nitrogen or lower alkanes. In some embodiments, the lower alkanes are selected from the group consisting of ethane, propane, butane, pentane, and hexane. In some embodiments, the molecular weight regulator is hydrogen. In some embodiments, the inert gas is nitrogen or propane. In some embodiments, the inert gas is used in combination with further lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, wherein part of the circulating reaction gas is cooled to below the dew point and returned to the reactor separately as a liquid, separately as a gas-phase, or together as a liquid-gas phase mixture, thereby using the enthalpy of vaporization for cooling the reaction gas.

As used herein, “multizone circulating reactors” refer to gas-phase reactors wherein two polymerization zones are linked to each another and the polymer is passed alternately a plurality of times through these two zones. In some embodiments, the reactors are as described in Patent Cooperation Treaty Publication Nos. WO 97/04015 A1 and WO 00/02929 A1. In some embodiments, the reactors have two interconnected polymerization zones, a riser, wherein the growing polymer particles flow upward under fast fluidization or transport conditions and a downcomer, wherein the growing polymer particles flow in a densified form under the action of gravity. The polymer particles leaving the riser enter the downcomer, and the polymer particles leaving the downcomer are reintroduced into the riser, thereby establishing a circulation of polymer between the two polymerization zones. In some embodiments, the polymer is passed a plurality of times through these two zones. In some embodiments, the two polymerization zones of a multizone circulating reactor are operated with different polymerization conditions by establishing different polymerization conditions in the riser and the downcomer. In some embodiments, the gas mixture leaving the riser and entraining the polymer particles is partially or totally prevented from entering the downcomer, by feeding a barrier fluid in form of a gas and/or a liquid mixture into the downcomer. In some embodiments, the barrier fluid is fed in the upper part of the downcomer. In some embodiments, the barrier fluid's composition differs from the gas mixture's composition present in the riser. In some embodiments, the amount of added barrier fluid is adjusted such that an upward flow of gas countercurrent to the flow of the polymer particles is generated, thereby acting as a barrier to the gas mixture entrained among the particles coming from the riser. In some embodiments, the countercurrent is at the top. In some embodiments, two different gas composition zones are obtained in one multizone circulating reactor. In some embodiments, make-up monomers, comonomers, molecular weight regulator, or inert fluids are introduced to the downcomer. In some embodiments, the molecular weight regulator is hydrogen. In some embodiments, the point of introduction is below the barrier feeding point. In some embodiments, varying monomer, comonomer, and hydrogen concentrations are created along the downcomer, thereby further differentiating the polymerization conditions.

In some embodiments, the gas-phase polymerization processes are carried out in the presence of a C₃-C₅ alkane as polymerization diluent, alternatively in the presence of propane. In some embodiments, the gas-phase polymerization process is for the homopolymerization or copolymerization of ethylene.

In some embodiments, the polymerization processes are connected in series, thereby forming a polymerization cascade. In some embodiments, the connected polymerization processes are identical or different. In some embodiments, a parallel arrangement of reactors of two or more different or identical processes is used.

In some embodiments, the polymerization of olefins is carried out in a reactor cascade of two or more gas-phase reactors. In some embodiments, the polymerization of olefins is carried out in a reactor cascade including a fluidized-bed reactor and a multizone circulating reactor. In some embodiments, the fluidized-bed reactor is arranged upstream of the multizone circulating reactor. In some embodiments, a reactor cascade of gas-phase reactors includes additional polymerization reactors. In some embodiments, the additional reactors are low-pressure polymerization reactors. In some the additional reactors are gas-phase reactors or suspension reactors. In some embodiments, the additional reactors include a pre-polymerization stage.

In some embodiments, the polymerization reaction is a Ziegler-Natta polymerization. In some embodiments, the pre-activated solid catalyst component is pre-polymerized prior to the polymerization reaction. In some embodiments, the polymerization catalyst system is prepared by (i) preparing a pre-activated solid catalyst component and (ii) pre-polymerizing the pre-activated solid catalyst component in the presence of one or more 1-olefins. In some embodiments, the pre-polymerization step occurs as described Patent Cooperation Treaty Publication No. WO 2014/184155 A1, the content of which is incorporated herein by reference in its entirety.

In some embodiments, the process is for the homopolymerization or copolymerization of ethylene or propylene, alternatively for the homopolymerization or copolymerization of ethylene. In some embodiments, the comonomers in propylene polymerization are up to 40 wt. % of ethylene or 1-butene, alternatively from 0.5 wt. % to 35 wt. % of ethylene or 1-butene. In some embodiments, up to 20 wt. %, alternatively from 0.01 wt. % to 15 wt. %, alternatively from 0.05 wt. % to 12 wt. %, of C₃-C₈-1-alkenes are used as comonomers in ethylene polymerization. In some embodiments, the alkanes are selected from the group consisting of 1-butene, 1-pentene, 1-hexene, and 1-octene. In some embodiments, ethylene is copolymerized with from 0.1 wt. % to 12 wt. % of 1-hexene and/or 1-butene.

### EXAMPLES

The poured bulk density (PBD) was determined according to DIN EN ISO 60:2000-01.

The density of polyethylene was determined according to DIN EN ISO 1183-1:2004, Method A (Immersion) with compression-molded plaques of 2 mm thickness. The compression-molded plaques were prepared with a defined thermal history: Pressed at 180° C., 20 MPa for 8 min with subsequent crystallization in boiling water for 30 min.

The melt flow rate MFR_{2.16} was determined according to DIN EN ISO 1133:2005, condition D at a temperature of 190° C. under a load of 2.16 kg.

The particle size distribution of the produced polyolefin particles was determined using a Tyler Testing Sieve Shaker RX-29 Model B, available from Combustion Engineering Endecott, provided with a set of twelve sieves, according to ASTM E-11-87, of 106, 125, 180, 300, 500, 710, 1000, 1400, 2000, 2800, 3350, and 4000 μm. The average particle diameter was determined according to ASTM D1921.

### Example 1

A high density polyethylene (HDPE) was prepared in a fluidized-bed reactor having an internal diameter of 800 mm. For pre-activating the solid catalyst component, the fluidized-bed reactor was equipped with two identical contacting vessels as shown in FIG. 1. The two contacting vessel were arranged in series. The diameter (D) of the main portions of the contacting vessels was 90 mm while the height (H) of the main portions of the contacting vessels was 250 mm, resulting in a ratio H/D of 2.8. The number of impellers was 3. The blade type was flat blade turbine.

A solid catalyst component was prepared in accordance with Example 6 of Patent Cooperation Treaty Publication No. WO 2018/114453 A1. The solid catalyst component was continuously fed into the first contacting vessel at a feeding rate of 28 g/h, using liquid propane as a diluent. In addition, triethylaluminum (TEA) was continuously fed into the first contacting vessel as activating compound in an amount of 3 g/g of solid catalyst component. The temperature in the first contacting vessel was maintained at 50° C. while continuously operating the impellers. The design of the contacting vessel allowed a complete mixing of the components while maintaining a plug-flow in the contacting vessel. The residence time in the first contacting vessel was 23 min.

The mixture discharged from the first contacting vessel was fed directly into the second contacting vessel. Additional liquid propane was fed into the second contacting vessel. The temperature in the second contacting vessel was maintained at 50° C. while continuously operating the impellers. The design of the contacting vessels allowed a complete mixing of the component while maintaining a plug-flow in the contacting vessel. The residence time in the second contacting vessel was 21 min.

The mixture discharged from the second contacting vessel was fed to the fluidized bed reactor. Additionally, ethylene (as monomer), hydrogen, trichloroethanol (TCEt) as activity enhancer, and an antistatic agent were fed into the fluidized bed reactor. The fluidized bed reactor was operated at 80° C. at a pressure of 2.7 MPa. Additional polymerization conditions are shown in Table 1 below.

The resulting HDPE homopolymer had a density of 0.970 g/cm³ and a melt flow rate MFR_{2.16} of 80 g/10 min. The production rate was 107 kg/h, and the productivity of the solid catalyst component was 4 250 g polymer/g catalyst solid, corresponding to a specific mileage of 6 420 g/(g·h·MPa). The polymer particle morphology of the resulting HDPE powder is shown in Table 1.

### Comparative Example A

The HDPE preparation of Example 1 was repeated under identical conditions; however, two identical conventional contacting vessels arranged in series were used for pre-activating the catalyst solid. The diameter (D) of the main portions of the contacting vessels was 100 mm while the height (H) of the main portions of the contacting vessels was 160 mm, resulting in a ratio H/D of 1.6. The number of impellers was 2. Flat blade turbines were installed on the agitator.

The feeding rate of the solid catalyst component of the polymerization catalyst system into the first contacting vessel was 33 g/h. The temperature in the first contacting vessel was maintained at 50° C. Operating the impellers resulted in a homogeneous mixture of the components throughout the contacting vessel. The residence time in the first contacting vessel was 21 min.

The mixture discharged from the first contacting vessel was fed directly into the second contacting vessel. The temperature in the second contacting vessel was maintained at 50° C. Operating the impellers resulted in a homogeneous mixture of the components throughout the contacting vessel. The residence time in the second contacting vessel was 20 min.

The mixture discharged from the second contacting vessel was fed into the fluidized bed reactor. The fluidized bed reactor was operated at 80° C. at a pressure of 2.7 MPa. Additional polymerization conditions are shown in Table 1 below.

The resulting HDPE homopolymer had a density of 0.971 g/cm³ and a melt flow rate MFR_{2.16} of 80 g/10 min. The production rate was 107 kg/h, and the productivity of the solid catalyst component was 3 240 g polymer/g catalyst solid, corresponding to a specific mileage of 5 360 g/(g·h·MPa). The properties of the produced polymer powder are shown in Table 1 below.

TABLE 1

| | | Comparative |
|---|---|---|
| | Example 1 | Example A |
| TEA/catalyst solid [g/g] | 0.3 | 0.3 |
| TCEt/catalyst solid [g/g] | 0.15 | 0.15 |
| Residence time in FBR [h] | 2.5 | 2.8 |
| C₂ [mol %] | 9.8 | 8.0 |
| H₂/C₂ [mol/mol] | 2.4 | 2.4 |
| Antistatic agent/produced HDPE [ppm wt.] | 107 | 112 |
| Polymer powder fraction < 180 [wt. %] | 0.9 | 0.7 |
| D₅₀ [μm] | 1130 | 1100 |
| PBD [g/cm³] | 0.408 | 0.400 |

### Example 2

Example 1 was repeated; however, a linear low density polyethylene (LLDPE) was prepared in the fluidized-bed reactor used in Example 1 being equipped with the two identical contacting vessels as shown in FIG. 1.

A solid catalyst component of the polymerization catalyst system was prepared in accordance with Example 2 of Patent Cooperation Treaty Publication No. WO 2012/025379 A1, using tetrahydrofuran (THF) as internal electron donor. The solid catalyst component had a THF content of 32.6 wt. %. The solid catalyst component was continuously fed into the first contacting vessel at a feeding rate of 13 g/h, using liquid propane as a diluent. Trihexylaluminum (THA), as a first activating compound, and cyclohexyl chloride (CHC), as activity enhancer, were continuously fed into the first contacting vessel. The temperature in the first contacting vessel was maintained at 40° C. while continuously operating the impellers. The design of the contacting vessel allowed a complete mixing of the components while maintaining a plug-flow in the contacting vessel. The residence time in the first contacting vessel was 115 min.

The mixture discharged from the first contacting vessel was fed directly into the second contacting vessel. Additional liquid propane and diethylaluminum chloride (DEAC), as a second activating compound, were fed into the second contacting vessel. The temperature in the second contacting vessel was maintained at 40° C. while continuously operating the impellers. The design of the contacting vessel allowed a complete mixing of the components while maintaining a plug-flow in the contacting vessel. The residence time in the second contacting vessel was 60 min.

The mixture discharged from the second contacting vessel was fed to the fluidized bed reactor. Additionally, ethylene (as monomer), 1-butene (as comonomer), hydrogen, and triethylaluminum (TEAL), as cocatalyst, were fed into the fluidized bed reactor. The fluidized bed reactor was operated at 86° C. at a pressure of 2.2 MPa. Additional polymerization conditions are shown in Table 2 below. The feeding rates of DEAC, THA, and TEAL were adjusted to have the ratios indicated below in Table 2 with respect to the THF as an internal donor in the solid catalyst component.

The resulting LLDPE homopolymer had a density of 0.920 g/cm³ and a melt flow rate MFR_{2.16} of 1.0 g/10 min. The production rate was 208 kg/h, and the productivity of the solid catalyst component was 16 000 g polymer/g catalyst solid, corresponding to a specific mileage of 27 250 g/(g·h·MPa).

### Comparative Example B

The LLDPE preparation of Example 2 was repeated under identical conditions; however, two identical contacting vessels arranged in series, as used in Comparative Example A, were used for pre-activating the catalyst solid.

The feeding rate of the solid catalyst component of the polymerization catalyst system into the first contacting vessel was 17 g/h. The temperature in the first contacting vessel was maintained at 40° C. Operating the impellers resulted in a homogeneous mixture of the components throughout the contacting vessel.

The mixture discharged from the first contacting vessel was fed directly into the second contacting vessel. The temperature in the second contacting vessel was maintained at 40° C. Operating the impellers resulted in a homogeneous mixture of the components throughout the contacting vessel.

The mixture discharged from the second contacting vessel was fed into the fluidized bed reactor. The fluidized bed reactor was operated at 86° C. and a pressure of 2.2 MPa. Additional polymerization conditions are shown in Table 2 below.

The resulting LLDPE homopolymer had a density of 0.918 g/cm³ and a melt flow rate MFR_{2.16} of 1.0 g/10 min. The production rate was 170 kg/h, and the productivity of the solid catalyst component was 10 000 g polymer/g catalyst solid, corresponding to a specific mileage of 20 000 g/(g·h·MPa).

TABLE 2

| | | Comparative |
|---|---|---|
| | Example 2 | Example B |
| DEAC/catalyst solid [g/g] | 0.25 | 0.23 |
| THA/catalyst solid [g/g] | 0.3 | 0.3 |
| TEA/catalyst solid [g/g] | 1.89 | 1.83 |
| Total alkyl/THF [mol/mol] | 4.4 | 4.2 |
| CHC/catalyst solid [g/g] | 0.075 | 0.075 |
| Residence time in FBR [h] | 1.2 | 1.3 |
| C₂ [mol %] | 22.6 | 17.5 |
| H₂/C₂ [mol/mol] | 0.14 | 0.12 |
| Bu/(Bu + C₂) [mol/mol] | 0.25 | 0.24 |

1. An apparatus for polymerizing olefins comprising:
a polymerization reactor and a vessel system for pre-activating a solid catalyst component, wherein the vessel system is arranged upstream of the polymerization reactor with respect to the flow of the solid catalyst component and comprises
(a) a contacting vessel comprising
(a.i) a main portion, wherein the main portion is a vertically arranged cylinder;
(a.ii) a base portion;
(a.iii) a head portion;
(a.iv) an inlet, connecting the space outside the contacting vessel with the inside of the contacting vessel; and
(a.v) an outlet, connecting the inside of the contacting vessel with the space outside the contacting vessel;
wherein the ratio (H/D) of the height (H) of the main portion to the diameter (D) of the main portion, calculated by dividing the height (H) by the diameter (D), is 1.8 or greater; and
a stirrer positioned within the contacting vessel,
wherein the stirrer is located at a position in the contacting vessel between the inlet and the outlet.

2. The apparatus of claim 1, wherein the contacting vessel comprises at least two inlets, connecting the space outside the contacting vessel with the inside of the contacting vessel.

3. The apparatus of claim 1, wherein the height (H) of the main portion is from 100 mm to 20 000 mm.

4. The apparatus of claim 1, wherein the diameter (D) of the main portion is from 20 mm to 5 000 mm.

5. The apparatus of claim 1, wherein the inlet and the outlet are situated in the vessel such that a height differential in the vertical direction exists between the respective positions of the inlet and the outlet.

6. The apparatus of claim 1, wherein the inlet is positioned such that material or fluid passing through the inlet into the contacting vessel enters the contacting vessel at a point above the uppermost stirrer and wherein the outlet is positioned such that material or fluid passing from the inside of the contacting vessel through the outlet exits the contacting vessel at a point below the lowermost stirrer.

7. The apparatus of claim 1, wherein the inlet is positioned such that material or fluid passing through the inlet into the contacting vessel enters the contacting vessel at a point below the lowermost stirrer and wherein the outlet is positioned such that material or fluid passing from the inside of the contacting vessel through the outlet exits the contacting vessel at a point above the uppermost stirrer.

8. The apparatus of claim 1, wherein the inlet and the outlet are vertically positioned in the contacting vessel such that material or fluid passing through the inlet into the contacting vessel and passing through the contacting vessel to the outlet passes along at least 75% of the height of the main portion prior to exiting the contacting vessel through the outlet.

9. The apparatus of claim 1, wherein the stirrer is a set of impellers.

10. The apparatus of claim 1, wherein the contacting vessel further comprises one or more baffles.

11. A process for preparing a pre-activated solid catalyst component for use in the polymerization of one or more 1-olefins, employs a vessel system comprising
(a) a contacting vessel comprising
(a.i) a main portion, wherein the main portion is a vertically arranged cylinder;
(a.ii) a base portion;
(a.iii) a head portion;
(a.iv) an inlet, connecting the space outside the contacting vessel with the inside of the contacting vessel; and
(a.v) an outlet, connecting the inside of the contacting vessel with the space outside the contacting vessel;
wherein the ratio (H/D) of the height (H) of the main portion to the diameter (D) of the main portion, calculated by dividing the height (H) by the diameter (D), is 1.8 or greater; and
(b) a stirrer positioned within the contacting vessel,
wherein the stirrer is located at a position in the contacting vessel between the inlet and the outlet,
and comprises the steps of:
(i) forming a mixture continuously feeding into the contacting vessel through the inlet
(i.i) a non-activated and/or partially activated solid catalyst component,
(i.ii) an activating compound comprising an organometallic compound of an element of Group 1, 2, 12, 13, or 14 of the Periodic Table of Elements,
(i.iii) a diluent,
and optionally
(i.iv) an external electron donor compound, or
(i.v) an activity enhancer compound selected from the group consisting of halogenated alkanols, haloalkanes, halocycloalkanes, and combinations thereof;
(ii) passing the mixture through the contacting vessel in the vertical direction to the outlet;
(iii) continuously removing the mixture containing the pre-activated solid catalyst component, through the outlet.

12. The process of claim 11, wherein the contacting vessel comprises at least two inlets, connecting the space outside the contacting vessel with the inside of the contacting vessel, and the non-activated and/or partially activated solid catalyst component is fed into the contacting vessel through a first of the inlets and the activating compound is fed into the contacting vessel through a second of the inlets.

13. The process of claim 11, wherein the pre-activated solid catalyst component is a pre-activated solid catalyst component for use in a Ziegler-Natta polymerization.

14. A process for preparing a polymer comprising the step of
polymerizing one or more 1-olefins in the presence of a polymerization catalyst system comprising a pre-activated solid catalyst component prepared according to the process of claim 11.

15. The process of claim 14, wherein the 1-olefins are selected from the group consisting of ethylene, propylene, 1-butene, 1-hexene, 1-octene, and combinations thereof.

16. The process of claim 11, wherein the height (H) of the main portion is from 100 mm to 20000 mm.

17. The process of claim 11, wherein the diameter (D) of diameter (D) of the main portion is from 20 mm to 5000 mm.

18. The process of claim 11, wherein the inlet and the outlet are situated in the vessel such that a height differential in the vertical direction exists between the respective positions of the inlet and the outlet.

19. The process of claim 11, wherein the inlet is positioned such that material or fluid passing through the inlet into the contacting vessel enters the contacting vessel at a point above the uppermost stirrer and the outlet is positioned such that material or fluid passing from the inside of the contacting vessel through the outlet exits the contacting vessel at a point below the lowermost stirrer.

20. The process of claim 11, wherein the inlet is positioned such that material or fluid passing through the inlet into the contacting vessel enters the contacting vessel at a point below the lowermost stirrer and the outlet is positioned such that material or fluid passing from the inside of the contacting vessel through the outlet exits the contacting vessel at a point above the uppermost stirrer.
